(19) United States
(12) Patent Application Publication
(10) Pub. No.: US 2010/0274554 A1
(43) Pub. Date: Oct. 28, 2010

(54) SPEECH ANALYSIS SYSTEM

(75) Inventors: Michael Christopher Orr, New South Wales (AU); Brian John Lithgow, Victoria (AU)

Correspondence Address: MERCHANT & GOULD PC, P.O. BOX 2903, MINNEAPOLIS, MN, 55402-0903, US

(73) Assignee: MONASH UNIVERSITY, Victoria (AU)

(21) Appl. No.: 11/993,792

(22) PCT Filed: Jun. 23, 2006
(86) PCT No.: PCT/AU2006/000889

§ 371 Date: Feb. 18, 2010

(30) Foreign Application Priority Data
Jun. 24, 2005 (AU) 2005903362

(51) Int. Cl. G10L 19/00

(52) U.S. Cl. 704/201; 704/E19.001

(57) ABSTRACT

A speech analysis system, including a kurtosis module for processing a coded sound signal to generate kurtosis measure data; a wavelet module for processing the coded sound signal to generate wavelet coefficients; and a classification module for processing the wavelet coefficients and the kurtosis measure data to generate label data representing a classification for the coded sound signal. The sound signal is classified as environmental noise, silence, speech from a single speaker, speech from multiple speakers, speech from a single speaker plus environmental noise, or speech from multiple speakers plus environmental noise. Speech is further classified as voiced or unvoiced.

### FIELD

The present invention relates to a speech analysis system and process.

### BACKGROUND

Speech analysis systems are used to detect and analyse speech for a wide variety of applications. For example, some voice recording systems perform speech analysis to detect the commencement and cessation of speech from a speaker in order to determine when to commence and cease recording of sound received by a microphone. Also, interactive voice response (IVR) systems used in communications networks perform speech analysis to also determine whether sounds received are to be processed as speech or otherwise.

Speech analysis or detection systems rely on models of speech to define the processes performed. Speech models based on analysis of amplitude-modulated speech have been published using synthesised speech, but have never been verified using continuous real speech and have been largely disregarded. Current speech analysis systems are based on speech models that rely on the filtering of a wide-band signal or the summation of received sinusoidal components. These systems, unfortunately, are unable to fully cater for both voiced (eg vowels a and e) and unvoiced speech (eg consonants s and f), and rely on separate processes for detecting the two types of speech. These processes assume there are two sources of speech to produce both types of sound. This of course is inconsistent with the fact that humans have only one set of lungs and one vocal tract, and therefore provide one source for speech.

Furthermore, current speech detection devices are only able to detect speech in quiet or very low level ambient noise environments, and assume that the speaker is talking in a normal voice. The devices do not work efficiently if the speaker is whispering or shouting, and noisy environments have a considerable effect on the device's performance.

Accordingly, it is desired to address the above, or at least provide a useful alternative.

### SUMMARY

In accordance with the present invention, there is provided a speech analysis system, including:
a kurtosis module for processing a coded sound signal to generate kurtosis measure data;
a wavelet module for processing said coded sound signal to generate wavelet coefficients; and
a classification module for processing said wavelet coefficients and said kurtosis measure data to generate label data representing a classification for said coded sound signal.

The present invention also provides a speech analysis process, including:
processing a coded sound signal to generate kurtosis measure data;
processing said coded sound signal to generate wavelet coefficients; and
processing said wavelet coefficients and said kurtosis measure data to generate label data representing a classification for said coded sound signal.

### BRIEF DESCRIPTION OF THE DRAWINGS

Preferred embodiments of the present invention are hereinafter described, by way of example only, with reference to the accompanying drawings, wherein:

FIG. 1 is a block diagram of a preferred embodiment of a speech analysis system;

FIG. 2 is a flow diagram of a process performed by a kurtosis module of the system;

FIG. 3 is a flow diagram of a process performed by a wavelet module of the system;

FIG. 4 is a flow diagram of a process performed by a decision module of the system;

FIG. 5 is an example of a kurtosis trace and features classified by the system; and

FIG. 6 is an example of wavelet coefficients produced and features classified by the system.

### DETAILED DESCRIPTION OF THE PREFERRED EMBODIMENTS

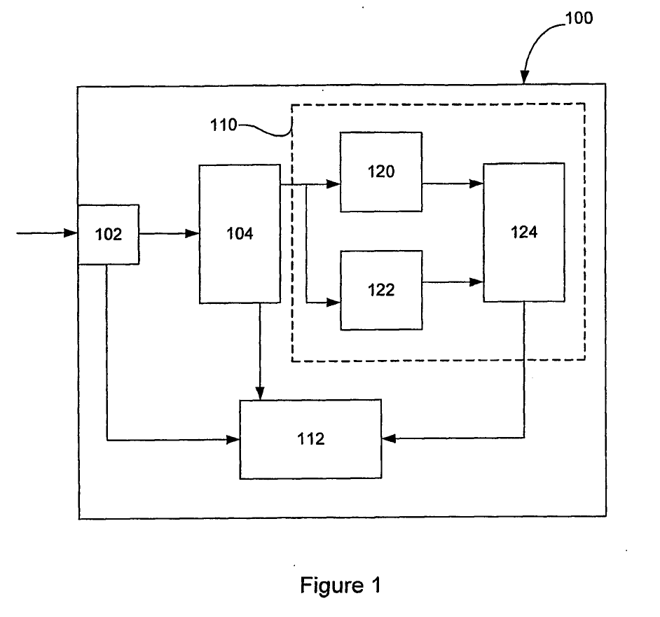

A speech analysis system 100, as shown in FIG. 1, includes a microphone 102, an audio encoder 104, a speech detector 110 and a speech processor 112. The microphone 102 converts the sound received from its environment into an analogue sound signal which is passed to both the encoder 104 and the speech processor 112. The audio encoder 104 performs analogue to digital conversion, and samples the received signal so as to produce a pulse code modulated (PCM) signal in an intermediate coded format, such as the WAV or AIFF format. The PCM signal is output to the speech detector 110 which analyses the signal to determine a classification for the received sound, eg whether the sound represents speech, silence or environmental noise. The detector 110 also determines whether detected speech is unvoiced or voiced speech.

The detector 110 outputs label data, representing the determination made, to the speech processor 112. On the basis of the label data received, the speech processor 112 processes the sound signal received from the microphone 102 and/or the PCM signal received from the encoder 104. The speech processor 100 is able to selectively store the received signals, as part of a recording function, and is also able to perform further processing depending on the application for the analysis system 100. For example, the analysis system 100 may be part of equipment recording conference proceedings. The system 100 may also be part of an interactive voice response (IVR) system, in which case the microphone 102 is substituted by a telecommunications line terminal for receiving a sound signal generated during a telecommunications call. The analysis system 100 may also be incorporated into a telephone conference base station to detect a party speaking.

The speech detector 110 includes a kurtosis module 120, a wavelet module 122 and a classification or decision module 124 for generating the label data. The kurtosis and wavelet modules 120 and 122 process the received coded sound signal in parallel. The kurtosis module 120, as described below, generates kurtosis measure data that represents the distribution of energy in the sound represented by the received sound signal. The wavelet module 122 includes 24 digital filters that decompose the sound from 125 Hz to 8 KHz using the complex Monet wavelet to generate wavelet coefficient data representing wavelet coefficients. The kurtosis measure data and the wavelet coefficient data are passed to the decision module 124. The decision module 124 processes the received kurtosis measure data and wavelet coefficient data to generate label data representing a classification of the currently received sound represented by the coded signal. Specifically, the sound is labelled or classified as either: (i) environmental noise, (ii) silence, (iii) speech from a single speaker, (iv) speech from multiple speakers, (v) speech from a single speaker plus environmental noise, or (vi) speech from multiple speakers plus environmental noise. When speech is labelled as being from a single speaker, it is also further categorised as either being voiced or unvoiced speech. The label data output changes in real-time to reflect changes in the received sound, and the speech processor 112 is able to operate on the basis of the detected changes. For example, the speech processor can activate recording for a transition from silence to speech from a single speaker and subsequently cease recording when the label data changes to represent environmental noise or silence. One application for labelling speech as being voiced or unvoiced is speech recognition.

The kurtosis module 120 produces a kurtosis measure which has a different value for ambient noise and for speech. Kurtosis is a statistical measure of the shape of the distribution of a set of data. The set of data has a finite length and the kurtosis is determined on the complete set of data. In order to be useful for a continuous sound signal, the kurtosis determination is performed in a reduced sense, as the signal is windowed before the kurtosis is determined and multiple windows are used across the whole signal, which involves partitioning the signal into finite, discrete and incomplete sets of data. The windows are discrete and independent, however, some of the data contained within them is included in more than one window. In other words, the windows of data partly overlap, but the processing performed on one window of the data does not affect the preceding or following windows.

Kurtosis measures can be generated directly from the sampled speech signal received by the module 120 in the time domain. Alternatively, kurtosis measures can be generated from to the signal after it has been transformed into a different type of representation, the time-frequency domain. Both domains are complete in their representation of the signal; however, the latent properties of their representations are different. In the time domain, the amplitude of the signal is only indirectly indicative of the signal's energy, and a transform is needed to indicate energy. In the time-frequency domain, the signal is represented as energy coefficients representing the energy in multiple frequency bands across time. Implicit in the transformation process from the time to the time-frequency domain is also an energy transformation. Each energy coefficient in the time-frequency domain, is a direct representation of the energy in a particular frequency band at a particular time.

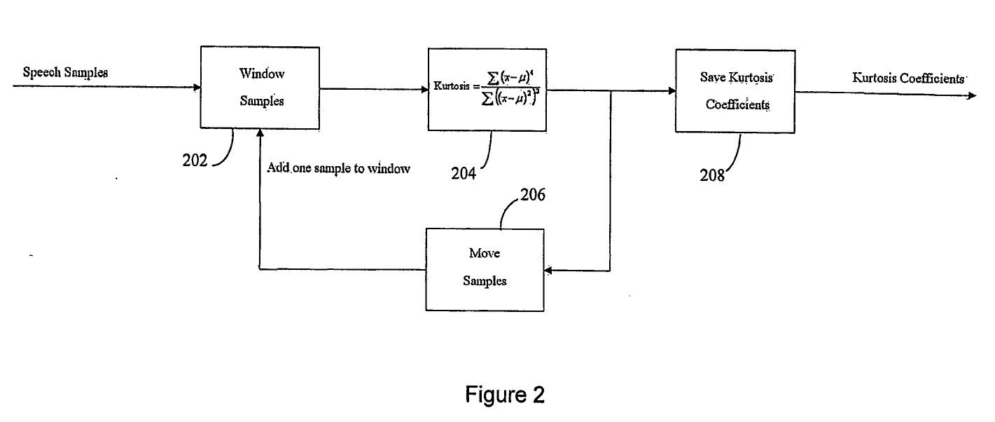

The kurtosis module 120 performs a kurtosis process, as shown in FIG. 2, for the time domain signal (or, if the time-domain signal has been transformed to the time-frequency domain, the frequency domain energy coefficient), which involves first windowing the speech sample signal (step 202). The window size is selected to maintain speech characteristics and is of the order of 5 to 25 milliseconds. For both the time domain signal and the time-frequency coefficients, a window size of 5 milliseconds is preferred because this has been found to maximise the localisation of short phonetic features, such as stop consonants.

The kurtosis process segments the data into a series of overlapping windows and for each window a kurtosis measure or coefficient (step 204) is generated as follows:

$$Kurtosis = \frac{\sum {( x - μ )}^{4}}{{( \sum {( x - μ )}^{2} )}^{2}} \qquad ( 1 )$$

where x represents the signal amplitude or energy coefficient, depending on the domain, and μ represents the mean value of x in the window. The windows are each independent, yet the data contained in a window is shifted by one sample from the adjacent window, as the windows are slid across the coded signal one sample at a time (step 206). The window sample set can be compared with the Gaussian distribution. Sample sets with a magnitude distribution ‘flatter’ or broader, than a Gaussian distribution is called ‘leptokurtic’, or more colloquially super-gaussian. Sample sets whose magnitude distribution is sharper, or tighter, than a Gaussian distribution are called ‘platykurtic’, or more colloquially sub-gaussian. In terms of first order statistics, the differences between leptokurtic and platykurtic are easier to understand. If the median of a sample set is smaller than the mean, the distribution is platykurtic. If the median of a sample set is larger than the mean, the distribution is leptokurtic.

For a number of basic signals, specific kurtosis values have been determined through speech modelling and phonetic interpretation, as described in Le Blanc, James P. and Phillip L. De Leon, (1998), Speech separation by kurtosis maximization, IEEE International Conference on Acoustics, Speech and Signal Processing, 2: 1029-1032.

Quantisation noise has kurtosis of 1.5, when synthetically created as a square wave. However, using recorded signals, the random process creating the noise produces a kurtosis value between 1-1.5.

A pure continuous single harmonic sinusoid has, in theory, a kurtosis of 1.5. However, in practice, the kurtosis value diverges from 1.5 for several reasons, including:
(i) The sinusoid having multiple harmonics with high amplitude.
(ii) An inappropriate window size being chosen for the analysis of the sinusoid. If the window size is less than a period of the sinusoid, the kurtosis may oscillate above 1.5. The period of oscillation is half the period of the sinusoid and the peak-to-peak amplitude of the oscillation is dependent on the fraction of the sinusoid period contained within the window. The smaller the percentage of the sinusoid in the window, the higher the average kurtosis value.
(iii) If the window contains more than one cycle of the sinusoid, but the period of the sinusoid is not a harmonic of the window size (i.e., the window size is not an integer multiple of the signal period), then the kurtosis will rise above 1.5 and oscillate with twice the period of the sinusoidal signal. However, the more cycles contained within the window, the smaller the peak-to-peak amplitude of the oscillation.
(iv) If the window for analysis contains an integer number of sinusoid oscillations, the kurtosis is exactly 1.5, no matter what size of window is used.

Given the above, a signal can reasonably be interpreted as containing predominantly sinusoids if the kurtosis is about 1.5-2.

As the window size is increased, the kurtosis measure of an amplitude modulated (AM) signal does converge to a value of 2.5 as the window size approaches infinity. However, similar to the sinusoid case, there are definite and predictable reasons why the kurtosis value does, in some cases, diverge from the value of 2.5. The kurtosis may drop below 2.5, ending up somewhere between 2-2.5, if the spectrum of the AM signal approaches that of a multiple sinusoid signal. A situation like this does occur when the frequency of the message signal is substantially different from that of the carrier signal. Similarly, the kurtosis of the AM signal may rise above 2.5 and converge towards 3 if the frequency components of the AM signal are very similar to those of a Guassian signal, since the kurtosis of a Gaussian signal is 3. Accordingly, a signal might be considered to be amplitude modulated if its kurtosis falls anywhere between 2 and 3.

Discontinuities in the signal being analysed produce large spikes in the kurtosis measure. The size of the spike is likely to be related to the magnitude of the discontinuity. It follows that the larger the drop (or rise) in value at the edge of the discontinuity, the larger the spike in kurtosis. Either side of the discontinuity, the kurtosis coefficients normally follow the kurtosis value appropriate for the signal. A signal can be considered to have a discontinuity if the kurtosis rises above 10, is rather parabolic in shape at the top of the rise, and then falls to a stable kurtosis value somewhere in the region it was previously.

It is unlikely that any of the above conditions will be met when analysing a signal representing speech.

Additional properties of the kurtosis measure are:
(a) Kurtosis by definition can never be negative for a real signal.
(b) Only in very special circumstances, via simulation, can the kurtosis of a signal drop below 1, into the range between 0-1.
(c) The kurtosis of a flat signal, containing no quantisation noise, in theory approaches infinity. However, it is extremely unlikely that a real sound signal would be so flat, though it is mathematically possible to prove that the resultant kurtosis value is infinite.
(d) Kurtosis is energy independent. Given a signal with a known kurtosis, amplifying the signal by 10,000 does not change the kurtosis.

For the time domain kurtosis process, applied to a time domain signal, the kurtosis coefficients generated (step 208) represent the distribution of the signal's amplitude over time, with one kurtosis coefficient generated for every signal sample. Each kurtosis coefficient is generated from all the samples in the corresponding window, and is considered to be representative of the central sample in that window. The sequence of kurtosis coefficients thus generated (as a stream of kurtosis measure data) can be considered to constitute a kurtosis ‘trace’ over time. The kurtosis trace provides an instantaneous measure at any given time or defined period that enables the identification of speech phonetic features in continuous voice. As described above, quantisation noise is represented by a kurtosis value of 1-1.5. Silence periods during speech are exactly that, periods of pure quantisation noise in the recording. It follows that anytime the kurtosis coefficient trace falls below or approaches 1.5, in all likelihood a silence or pause in the speech has occurred. Voiced speech is highly structured and represents a complex amplitude-modulated waveform. Therefore, depending on the message and carrier frequencies of the complex amplitude modulated signal, kurtosis values ranging from 2-3 and largely stable for 100 milliseconds or more indicate that the speech at that point is highly likely to be voiced. A characteristic of unvoiced speech is the low amplitude of the sound, which leads to a statistically flat, or broad, amplitude distribution. Accordingly, unvoiced speech is characterised by a leptokurtic distribution and represented by kurtosis values of 3-6.

There are also exceptions that need to be taken into account. Speech signal accentuation and intonation of the voice leads to a rise in the kurtosis measure compared with the same person saying the same speech in a monotone voice. Accentuation generally leads to a sharp rise and fall in kurtosis, much like a discontinuity, corresponding in time with the accented speech. The musical melody of intonation normally leads to an overall rise in the kurtosis values. This is detected from the kurtosis trace as a sharp rise in kurtosis values for accentuation and a gentle rise then fall in kurtosis values within a time period of a phoneme, i.e. about 100 ms.

Applying the kurtosis process to the transformed coded signal, so as to operate in a time-frequency domain, allows the module 120 to perform the kurtosis analysis two-dimensionally. In the time domain, only the amplitude is present for analysis, but in the time-frequency domain, both energy and frequency values are available for analysis. If the frequency bands are treated separately and the analysis applied to each band, then this provides a similar analysis to that provided for the time domain. Accordingly, the frequency bands are grouped into wider bands that nevertheless still have relevance to the underlying signals to allow identification of phonetic features. The frequency bands, in this case wavelet coefficients produced by the wavelet module 122, are grouped according to averaged speech formant frequencies. The purpose of the grouping is to identify the time at which the formant frequencies change. Fourier transform based approaches with optimisation algorithms to merely detect the formants have been described previously, but cannot be used to determine the moment when the formats change, as discussed in Hermes, Dick J., (1988), “Measurement of pitch by subharmonic summation”, Journal of the Acoustical Society of America, 83(1): 257-264; and also in Stubbs, Richard J. and Quentin Summerfield, (1990), “Algorithms for separating the speech of interfering talkers: Evaluations with voiced sentences, and normal-hearing and hearing-impaired listeners”, Journal of the Acoustical Society of America, 87(1): 359-372.

After grouping the frequency bands for the first four formants, the coefficients in those bands are added at each time location, to provide a representation of the formant coefficient or total formant energy at a particular time. Once the formant coefficients are determined for the whole signal, the kurtosis determination of equation 1 is applied to them individually. The formant coefficients can be determined from previously known data using Fant, G (1960) “Acoustic theory of speech production” 1st ed: Mouton & Co. The resultant trace of kurtosis coefficients represents the distribution of energy in a particular formant as a function of time. The higher the kurtosis, the flatter the energy distribution is, therefore the less the formant's energy is changing. The kurtosis does not indicate the total energy of the signal, but rather its distribution, and by processing the trace of the formant's kurtosis, taking particular note of falls in the kurtosis values, an indication of the timing for formant energy changes can be determined. Using characteristics of phonetics, the energy change of a formant can then be related to changes in frequency and sounds annotated.

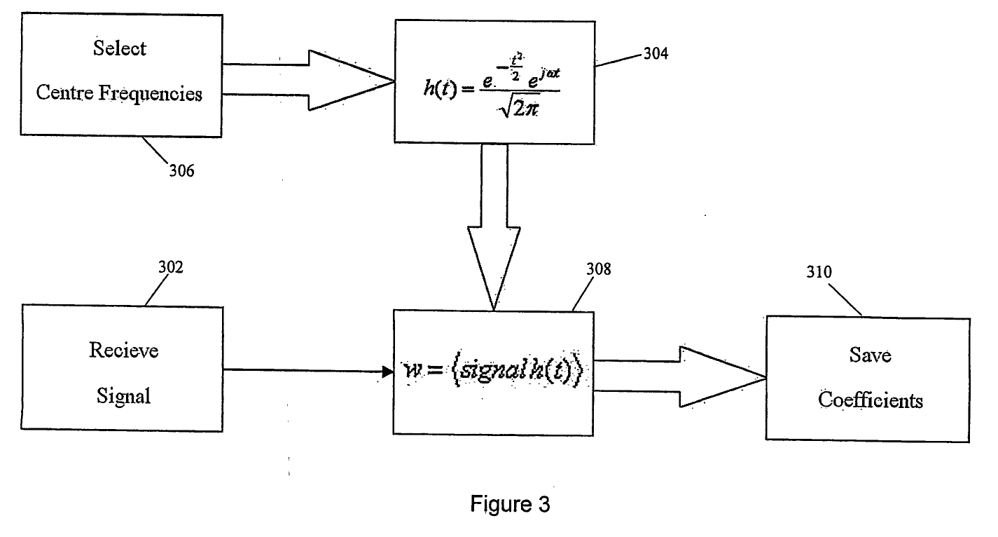

As shown in FIG. 3, the wavelet module 122, receives the coded sound signal (step 302) and performs a wavelet process based on the complex Morlet wavelet. The wavelet module 122 uses 24 digital filters that each apply the complex Morlet wavelet transform (step 304) at a corresponding centre frequency ω (step 306), the centre frequency being the location of the peak of the Morlet filter transfer function (step 304 in FIG. 3). The 24 digital filters, spaced apart in frequency by ¼ octave, decompose the sound from 125 Hz to 8 KHz (being the frequency range from the lowest frequency with which male vocal chords are expected to oscillate to a frequency capable of modelling most of the energy of fricative sounds). The transform for each centre frequency is applied to the received signal (step 308) to generate wavelet coefficient data representing a set of wavelet coefficients that are saved (step 310) and passed to the decision module 124. The wavelet process performed by the wavelet module 122 is further described in Orr, Michael C., Lithgow, Brian J., Mahony, Robert E., and Pham, Duc Son, “A novel dual adaptive approach to speech processing,” in Advanced Signal Processing for Communication Systems, Wysocki, Tad, Darnell, Mike, and Honary, Bahram, Eds.: Kluwer Academic Publishers, 2002 (Orr 2002).

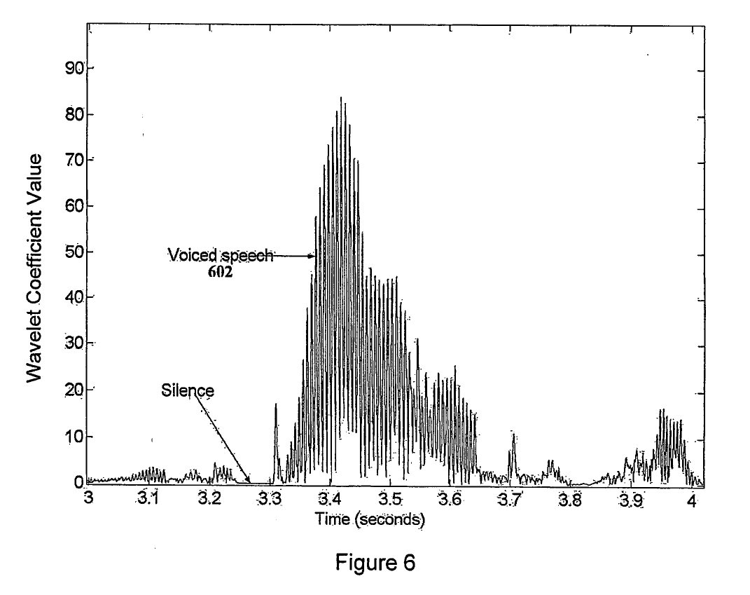

The decision module 124 receives kurtosis measure data representing the kurtosis measures or coefficients as they are generated, and wavelet coefficient data representing the wavelet coefficients from the wavelet module 122, and generates the label data based on the following:
(i) If a value of the kurtosis data is approximately 2.5, within the range of 1.75-3, and oscillations of the wavelet coefficients occur with a substantially constant frequency greater than about 80 Hz (the lowest frequency expected for male vocal chords, which typically vibrate at a frequency of at least about 125 Hz) and less than about 500 Hz (the highest frequency expected for a child's vocal chords) (i.e., a range consistent with a human voice), as shown in the voiced section 602 of FIG. 6, then the sound is labelled voiced speech.
(ii) If the kurtosis has risen dramatically in the last 100 milliseconds and is now above 3, and the wavelet coefficient amplitude has not dramatically fallen but has stayed the same or has slightly risen, then the sound is probably speech, and is labelled as such.
(iii) If the kurtosis has fallen below 2, then the sound is labelled silence.
(iv) If the wavelet coefficients are not oscillating and the kurtosis is 3 or higher, then the sound is probably environmental.
(v) If the kurtosis value is slightly (typically 0.25-0.75 times) higher than normal for speech, ie above 3, and the wavelet coefficient amplitude is less than that of voiced speech for the same speaker (Voiced speech for the speaker having been identified previously), and the wavelet coefficients are oscillating but at slightly different frequency than the same speaker's voiced sounds, then the sound is speech but most likely unvoiced speech. For multiple speakers, there will likely be more than one F0 (the frequency of a speaker's vocal chords) present both in voiced and unvoiced components. This can be used for separation and identification
(vi) If a very sharp (occurring over a time period of less than about 1 ms) rise in kurtosis from below 3 to value of at least about 6 is followed by a slower (occurring over a time period of at least about 3-10 ms) reduction in kurtosis, and the same pitch frequency is present and additional frequencies in the 120-400 Hz range are present in the wavelet coefficient oscillations, then the sound is speech but with very strong intonation/emphasis cue.
(vii) Multiple speakers are detected by the kurtosis coefficients converging towards 3. This means that the detection of unvoiced speech is at the lower end of the detection range and the voiced speech higher than that for single speakers.
(viii) Environmental noise is detected if a constant kurtosis value of 3 is received.

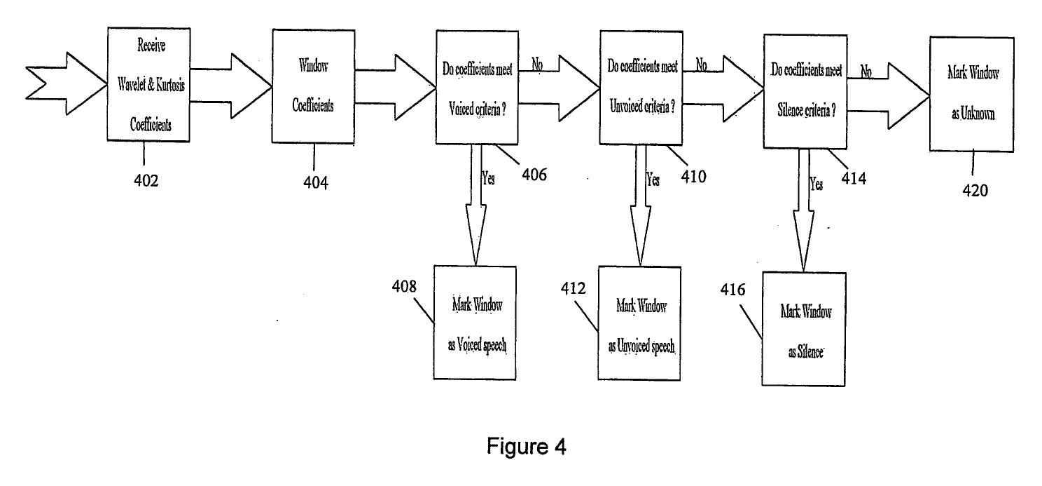

The decision module is able to execute a decision process, as shown in FIG. 4, where firstly the data representing the wavelet coefficients and kurtosis values are received from the kurtosis module 120 and the wavelet module 122 (step 402). A window is applied to the coefficients (step 404), with the size of the window based upon the size of a phoneme (phoneme size being ˜30-280 ms). For running speech, a window size of 3-10 ms is appropriate. For individual phonemes, the window can be approximately equal to the phoneme length. If the received data meet the voiced speech criteria (i) (step 406) then the window is labelled as representing voice speech (step 408). Otherwise, if the coefficients are considered to meet the unvoiced speech criteria being (i) and (v) discussed above (step 410), then the window is labelled as representing unvoiced speech (step 412).

Otherwise, if the coefficients meet the silence criteria (iii) (step 414), then the window is labelled as silence (step 416). Otherwise, if the coefficients do not meet any of the specified criteria of the decision process (steps 406 to 414), then the window is labelled as unknown (step 410).

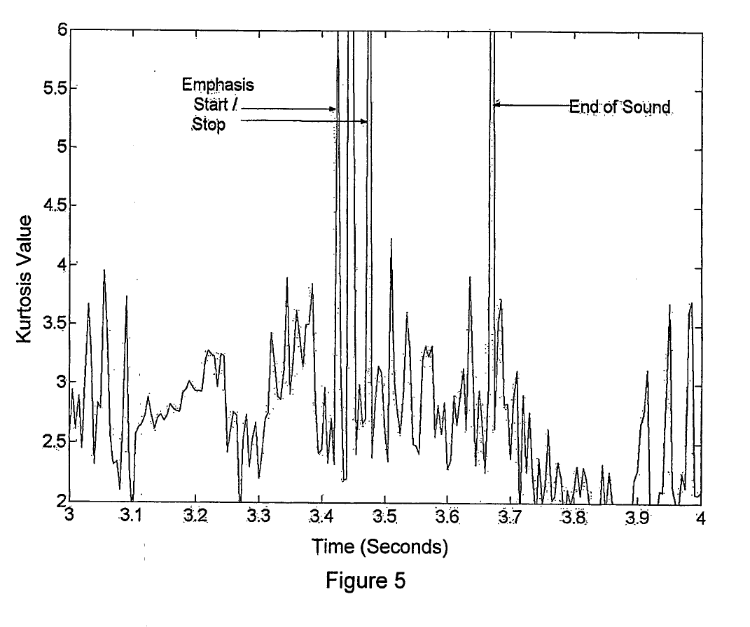

FIGS. 5 and 6 show examples of the kurtosis and wavelet coefficients, respectively, generated from a coded sound signal obtained from the Australian National Database of Spoken Language (file s017s0124.wav). The kurtosis and the wavelet data were generated by the kurtosis module 120 and the wavelet module 122, respectively, and the labels illustrated were determined by the decision module 124.

The analysis system 100 may be implemented using a variety of hardware and software components. For example, standard microphones are available for the microphone 102 and a digital signal processor, such as the Analog Devices Blackfin, can be used to provide the encoder 104, detector 110 and the speech processor 112. To enhance performance, the components 104, 110 and 112 can be implemented as dedicated hardware circuits, such as ASICs. The components 104, 110 and 112 and their processes can alternatively be provided by computer software running on a standard computer system.

The speech analysis system and process described herein can be used for a wide variety of applications, including covert monitoring/surveillance in noisy environments, “legal” speaker identification, separation of speech from background/environmental noise, detecting a motion, stress, and/or depression in speech, and in aircraft/ground communication systems.

Many modifications will be apparent to those skilled in the art without departing from the scope of the present invention as hereinbefore described with reference to the accompanying drawings.

1. A speech analysis system, including:
a kurtosis module for processing a coded sound signal to generate kurtosis measure data;
a wavelet module for processing said coded sound signal to generate wavelet coefficients; and
a classification module for processing said wavelet coefficients and said kurtosis measure data to generate label data representing a classification for said coded sound signal.

2. The speech analysis system of claim 1, further including an input module for generating said coded sound signal from received sound.

3. The speech analysis system of claim 1 or 2, wherein the coded sound signal is pulse code modulated (PCM).

4. The speech analysis system of any one of claims 1 to 3, wherein a classification represented by said label data includes one of environmental noise, silence, speech from a single speaker, speech from multiple speakers, speech from a single speaker plus environmental noise, and speech from multiple speakers plus environmental noise.

5. The speech analysis system of any one of claims 1 to 3, wherein said classification module is adapted to select the classification of said coded sound signal from: environmental noise, silence, speech from a single speaker, speech from multiple speakers, speech from a single speaker plus environmental noise, and speech from multiple speakers plus environmental noise.

6. The speech analysis system of claim 4 or 5, wherein speech classified as being from a single speaker is further classified as being voiced or unvoiced.

7. The speech analysis system of any one of claims 1 to 6, wherein the system is adapted to generate said kurtosis measure data, said wavelet coefficients, and said label data substantially in real-time to be responsive to changes in said coded sound signal.

8. A speech analysis process, including:
processing a coded sound signal to generate kurtosis measure data;
processing said coded sound signal to generate wavelet coefficients; and
processing said wavelet coefficients and said kurtosis measure data to generate label data representing a classification for said coded sound signal.

9. The speech analysis process of claim 8, wherein said classification includes one of:
environmental noise, silence, speech from a single speaker, speech from multiple speakers, speech from a single speaker plus environmental noise, and speech from multiple speakers plus environmental noise.

10. The speech analysis process of claim 8, wherein said classification is selected from: environmental noise, silence, speech from a single speaker, speech from multiple speakers, speech from a single speaker plus environmental noise, and speech from multiple speakers plus environmental noise.

11. The speech analysis process of claim 9 or 10, wherein a coded sound signal classified as being speech from a single speaker is further classified as being voiced or unvoiced.

12. The speech analysis process of any one of claims 8 to 11, wherein said kurtosis measure data, said wavelet coefficients, and said label data are generated substantially in real-time to be responsive to changes in said coded sound signal.

13. The speech analysis process of any one of claims 8 to 12, wherein said step of processing of said wavelet coefficients and said kurtosis measure data includes selecting subsets of said kurtosis measure data and said wavelet coefficients corresponding to respective time-windows.

14. The speech analysis process of claim 13, wherein said time-windows are about 3-10 ms in length to analyse running speech.

15. The speech analysis process of claim 13, wherein said time-windows are about 30-280 ms in length to analyse individual phonemes.

16. The speech analysis process of any one of claims 8 to 15, wherein said step of processing of said wavelet coefficients and said kurtosis measure data includes classifying a portion of said coded sound signal as speech if a corresponding subset of said kurtosis measure data is greater than 1.75, less than 3, and substantially equal to about 2.5; and a corresponding subset of said wavelet coefficients includes oscillations having a frequency greater than about 150 Hz and corresponding to a pitch of speech.

17. The speech analysis process of claim 16, includes classifying said portion of said coded sound signal as unvoiced speech if the corresponding subset of said kurtosis measure data is about 0.25-0.75 times greater than that of voiced speech from the same person, and said corresponding subset of said wavelet coefficients has an amplitude less than that of a previous subset of said wavelet coefficients classified as voiced speech, and said corresponding subset of said wavelet coefficients includes oscillations having a frequency different from that of the previous subset of said wavelet coefficients.

18. The speech analysis process of claim 16, includes classifying said portion of said coded sound signal as voiced speech if said portion of said coded sound signal was not classified as unvoiced speech.

19. The speech analysis process of any one of claims 8 to 18, wherein said step of processing of said wavelet coefficients and said kurtosis measure data includes classifying a portion of said coded sound signal as silence if a corresponding subset of said kurtosis measure data is less than about 2.

20. The speech analysis process of any one of claims 8 to 19, wherein said step of processing of said wavelet coefficients and said kurtosis measure data includes classifying a portion of said coded sound signal as environmental if a corresponding subset of said kurtosis measure data is at least about 3 and a corresponding subset of said wavelet coefficients does not include substantial oscillations.

21. The speech analysis process of any one of claims 8 to 20, wherein said step of processing of said wavelet coefficients and said kurtosis measure data includes classifying a portion of said coded sound signal as having a strong intonation or emphasis if a corresponding subset of said kurtosis measure data includes an increase from less than about 3 to at least about 6 over a time period of less than about 1 ms, followed by a reduction to at most about 3 over a time period of at least about 3-10 ms, and a corresponding subset of said wavelet coefficients includes a plurality of frequencies, including at least one of said frequencies always being present.

22. The speech analysis process of any one of claims 8 to 21, wherein said step of processing of said wavelet coefficients and said kurtosis measure data includes classifying a portion of said coded sound signal as including speech from multiple speakers if a corresponding subset of said kurtosis measure data converges towards a value of about 3.

23. The speech analysis process of any one of claims 8 to 22, wherein said coded sound signal represents signal amplitude values in a time-domain.

24. The speech analysis process of any one of claims 8 to 22, wherein said coded sound signal represents energy coefficients in a frequency-time domain.

25. The speech analysis process of claim 24, including generating said coded sound signal from a time-domain sound signal.

26. The speech analysis process of any one of claims 8 to 25, wherein said kurtosis measure data represents kurtosis measures generated according to:
$$Kurtosis = \frac{\sum {( x - μ )}^{4}}{{( \sum {( x - μ )}^{2} )}^{2}}$$

27. A system having components for executing the steps of any one of claims 8 to 26.

28. A computer-readable storage medium having stored thereon program instructions for executing the steps of any one of claims 8 to 26.
